(19) United States
(12) Patent Application Publication
(10) Pub. No.: US 2016/0294270 A1
(43) Pub. Date: Oct. 6, 2016

(54) LINEAR RESONANT ACTUATOR

(71) Applicant: TOPRAY MEMS INC., Hsinchu City (TW)

(72) Inventors: Chin-Sung LIU, Hsinchu City (TW); Ping-Ju CHANG, Hsinchu City (TW)

(73) Assignee: TOPRAY MEMS INC., Hsinchu City (TW)

(21) Appl. No.: 14/940,827

(22) Filed: Nov. 13, 2015

(30) Foreign Application Priority Data
Apr. 2, 2015 (TW) 104205051

(51) Int. Cl. H02K 33/06

(52) U.S. Cl. CPC H02K 33/06

(57) ABSTRACT

According to an exemplary embodiment, a linear resonant actuator includes A linear vibration actuator comprises a movable element group, a coil, a pair of elastic member, and a base. The movable element group further includes a yoke and a pair of magnet set, with same magnetic poles of the pair of magnet set disposed on two corresponding sides of the yoke. A movable portion connecting end of the elastic member is connected to the magnet set, a fixed end of the elastic member is fixed to a base. The coil is disposed on periphery of said yoke, and the coil is fixed to the base. When a continuous alternating current is applied on the coil, the movable element group is enabled to produce a simple harmonic motion.

### CROSS-REFERENCE TO RELATED APPLICATION

The present application is based on, and claims priority form, Taiwan Patent Application No. 104205051, filed Apr. 02, 2015, the disclosure of which is hereby incorporated by reference herein in its entirety.

### TECHNICAL FIELD

The technical field generally relates to a resonant actuator, and in particular, a linear resonant actuator.

### BACKGROUND

Recently available portable electronic products such as mobile phones and tablet PCs bear vibration function. In addition of providing reminding usage of mute mode, the vibration function also provides vibration feedback mechanism when operating key-in of no key pads. This vibration feedback mechanism can produce a slight buzz when the user is in the use of such key-in, causing the user to acknowledge key-in operation has been completed. Currently the popular vibration mechanism is the usage of eccentric rotary motor to provide source of vibration. The response speed of the eccentric rotary motor induces sluggish phenomenon, and also the power consumption becomes another criticized issue of the eccentric rotary motor. This is most notably due to complex design of the eccentric rotary motor, and also its components are easily damaged. Therefore a linear resonant actuator is used to solve the disadvantages of the eccentric rotary motor.

### SUMMARY

The present disclosure provided a linear resonant actuator comprises a movable element group, a coil, a pair of elastic member, and a base. The movable element group further includes a yoke and a pair of magnet set, with same magnetic poles of said pair of magnet set disposed on two corresponding sides of the yoke. A movable portion connecting end of elastic member is connected to the magnet set, a fixed end of the elastic member is fixed to a base. The coil is disposed on periphery of said yoke, and the coil is fixed to the base. When a continuous alternating current (A/C) is applied on the coil, the movable element group is enabled to produce a simple harmonic motion.

The foregoing will become better understood from a careful reading of a detailed description provided herein below with appropriate reference to the accompanying drawings.

### BRIEF DESCRIPTION OF THE DRAWINGS

FIG. 1 shows a schematic diagram of a linear resonant actuator, according to an exemplary embodiment of the disclosure.

FIG. 2 is a schematic diagram of magnetic force showing magnetic force and direction of action of the linear resonant actuator, according to an exemplary embodiment of the disclosure.

FIG. 3 is a schematic diagram showing the extended movable element group, according to an exemplary embodiment of the disclosure.

FIG. 4 is a schematic diagram showing the elastic member, according to an exemplary embodiment of the disclosure.

FIG. 5 is another schematic diagram showing the elastic member, according to an exemplary embodiment of the disclosure.

FIG. 6 is a schematic diagram showing the implementation of the elastic member in FIG. 5, according to an exemplary embodiment of the disclosure.

FIG. 7 is a schematic diagram showing an upper cover of the linear resonant actuator, according to an exemplary embodiment of the disclosure.

### DETAILED DESCRIPTION OF THE DISCLOSED EMBODIMENTS

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

The present invention provides a linear resonant actuator with magnetic coil more concentrated, such that the linear resonant actuator results in advantages of faster response and less power consumption.

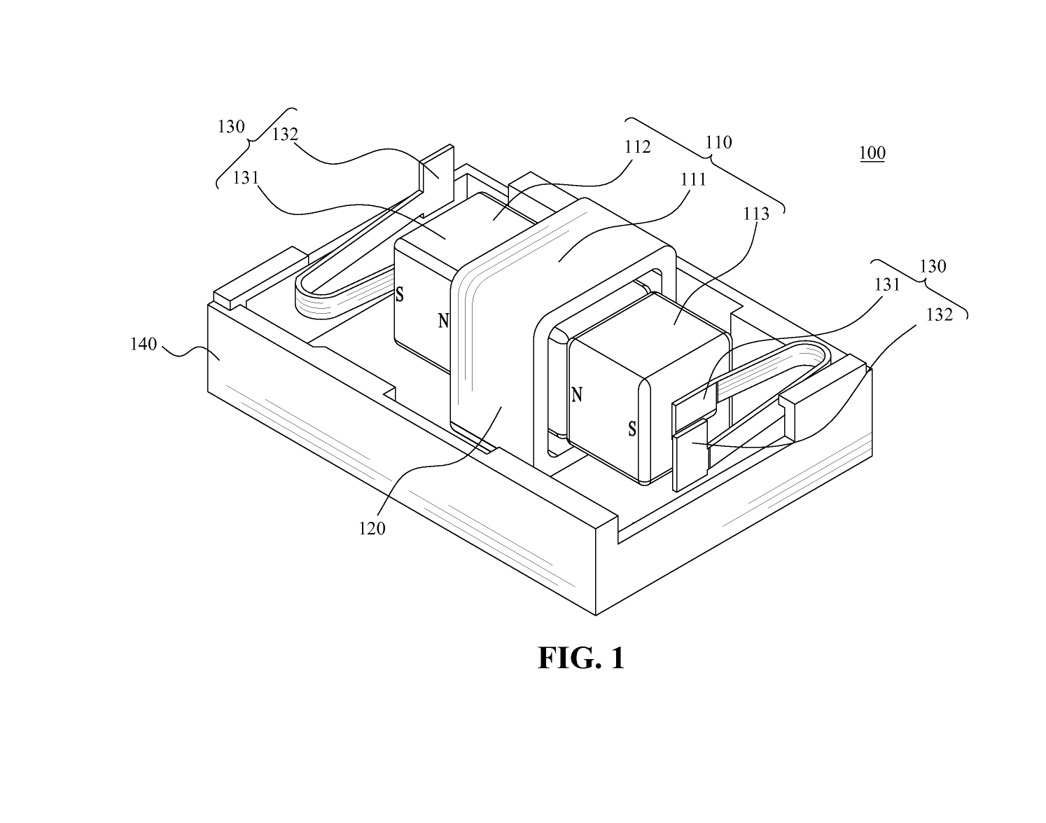

FIG. 1 shows a schematic diagram of a linear resonant actuator, according to an exemplary embodiment of the disclosure. As shown in FIG. 1, the linear resonant actuator 100 comprises a movable element group 110, a coil 120, a pair of elastic member 130, and a base 140. The movable element group 110 further includes a yoke 111 and a pair of magnet set 112, 113. The same magnetic poles of the pair of magnet set 112, 113 are disposed on two corresponding sides of the yoke 111. A movable portion connecting end 131 of the elastic member 130 is connected to the pair of magnet set 112,113, and a fixed end 132 of the elastic member 130 is fixed to the base 140. The coil 120 is disposed on the periphery of the yoke 111, and the coil 120 is fixed to the base 140. When a continuous alternating current (A/C) is applied on the coil 120, the movable element group 110 is enabled to produce a simple harmonic motion (SHM), wherein the same magnetic pole is N pole or S pole.

Following the above, the linear resonant actuator is disposed on a mobile device, such as mobile phone, tablet PC, or device with vibration feedback, to provide vibration needed by the mobile device. In addition the linear resonant actuator features fast response time and power saving characteristics.

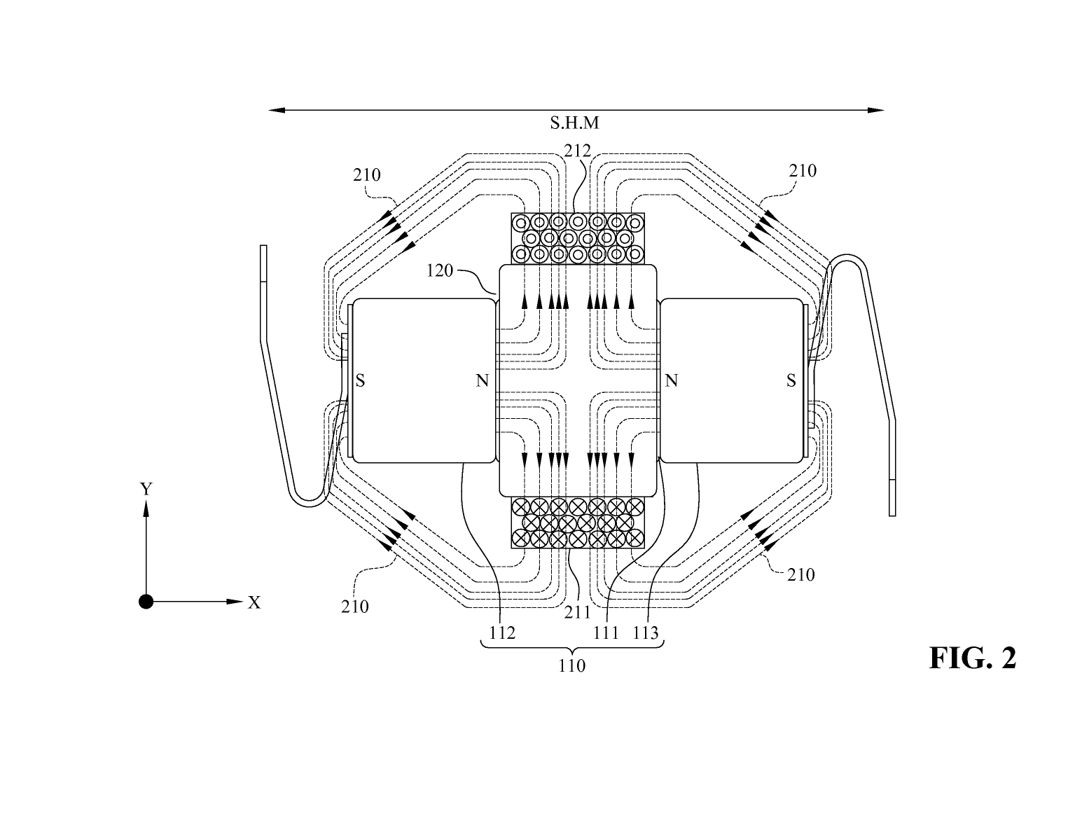

FIG. 2 is a schematic diagram of magnetic force showing magnetic force and direction of action of the linear resonant actuator, according to an exemplary embodiment of the disclosure. As shown in FIG. 2, the movable portion 110 includes a yoke 111 and the magnet set 112, 113, wherein the same magnetic pole of the magnet set 112, 113 are disposed on two corresponding sides of the yoke 111, separately, wherein the same magnetic pole is N pole. When a continuous current is applied on the coil 120, the inbound direction (vertical direction into the page) 211 and the outbound direction (vertical direction out of the paper) 212 of the current on the coil may react with +Y direction and −Y direction of the magnetic force produced by the magnet set of mutually exclusive, respectively. According to Fleming's left hand rule, two sections of the coil may simultaneously produce push force on the −X direction for the movable portion 110 and induce vibration. Then when an alternating current is applied on the coil, the movable portion 110 may produce a simple harmonic motion (SHM). Since four sides of the yoke 111 are surrounded by the coil 120, the coil 120 is used for efficient usage range to induce concentrated magnetic field and guided magnetic direction.

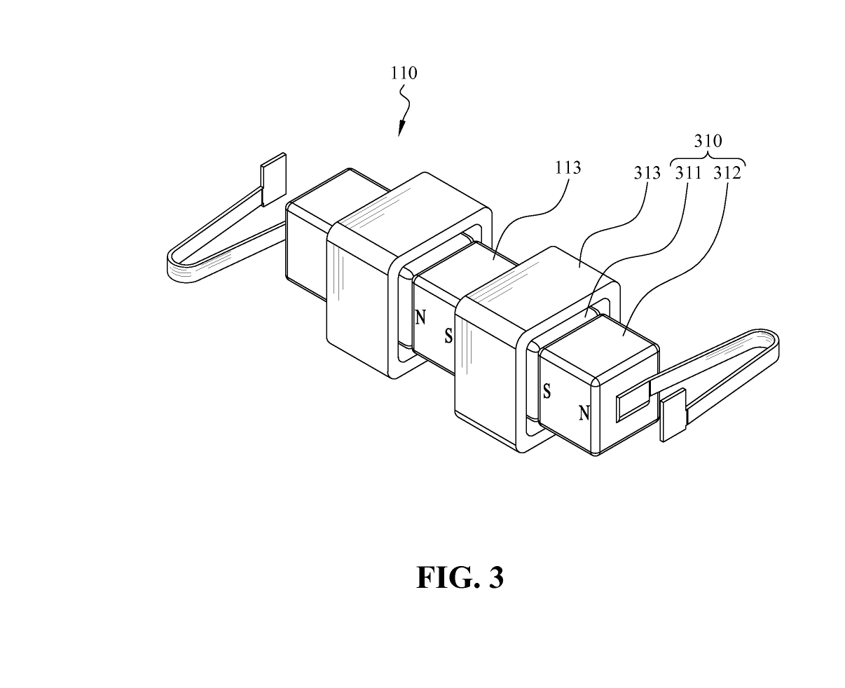

FIG. 3 is a schematic diagram showing the extended movable element group, according to an exemplary embodiment of the disclosure. As shown in FIG. 3, the linear resonant actuator further comprises at least one extended movable element group 310 and a coil 313. The extended movable element group 310 consists of a yoke 311 and a magnet 312. One end of the yoke 311 is connected to the magnet 113, the coil 313 is disposed around the periphery of the yoke 311, the magnet 312 is connected to the other end of the yoke 311. When the magnet 312 is connected to the yoke 311, the manner of same magnetic pole must be performed, i.e., when the magnetic of connecting the yoke 311 and the magnet 113 is S pole, the magnetic of connecting the yoke 311 and the magnet 312 must also be S pole. This extended movable element group may increase to become a plurality of extended element group and also a plurality of coil according to the needs of usage.

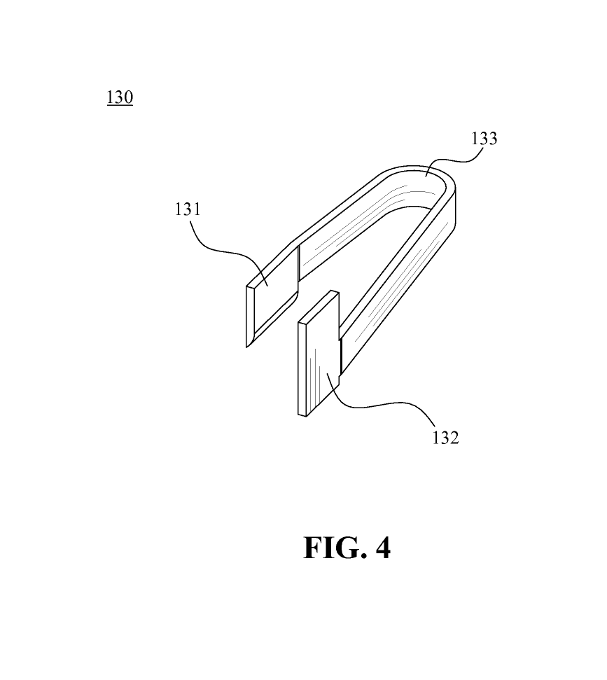

FIG. 4 is a schematic diagram showing the elastic member, according to an exemplary embodiment of the disclosure. As shown in FIG. 4, the elastic member 130 comprises a movable portion connecting end 131, a fixed end 132, and a suspension spring 133. The suspension spring 133 is connected to the movable portion connecting end 131 and the fixed end 132. Wherein the elastic member is a material having spring characteristics, and the material having spring characteristics is a sheet spring having elastic material of copper alloy, or stainless steel; the spring constant of the elastic member is determined by shape and material of said elastic member, and characteristics adjustment of simple harmonic motion is obtained by adjusting shape or material to a suitable spring constant.

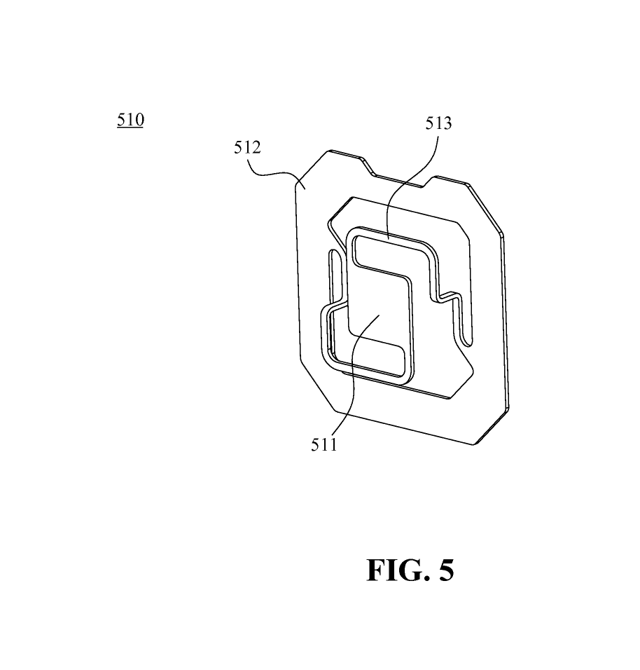

FIG. 5 is another schematic diagram showing the elastic member, according to an exemplary embodiment of the disclosure. As shown in FIG. 5, the elastic member 510 includes a movable portion connecting end 511, a fixed end 512, and a suspension spring 513. The suspension spring 513 is connected to the movable portion connecting end 511 and the fixed end 512. The elastic member 510 in the exemplary embodiment of FIG. 5 is a square type, but is not limited to the shape of this exemplary embodiment.

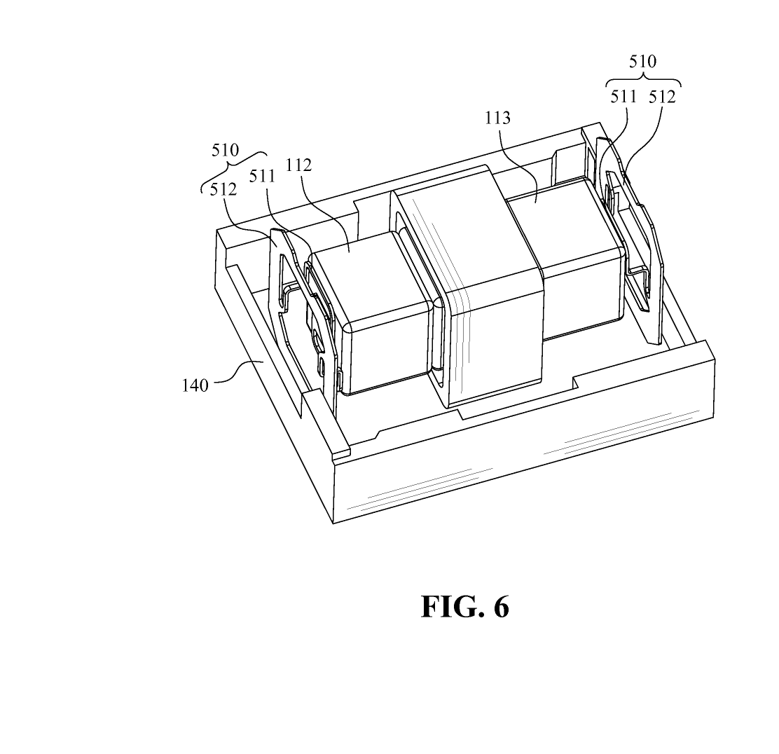

FIG. 6 is a schematic diagram showing the implementation of the elastic member in FIG. 5, according to an exemplary embodiment of the disclosure. As shown in FIG. 6, the movable portion connecting end 511 of the elastic member 510 is connected to the magnet 112, 113; the fixed end 512 of the elastic member 510 is fixed to the base 140.

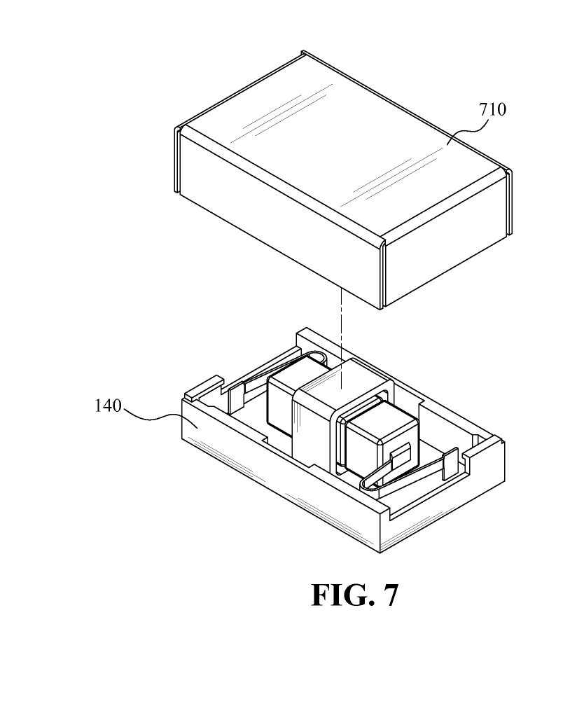

FIG. 7 is a schematic diagram showing an upper cover of the linear resonant actuator, according to an exemplary embodiment of the disclosure. As shown in FIG. 7, the linear resonant actuator 10 may further include an upper cover 710, wherein the upper cover 710 is combined with the base 140, to provide effective protection of the linear resonant actuator through the base 140 and the upper cover 710.

In summary, the present disclosure provides a linear resonant actuator with periphery of a yoke surrounded by a coil, so that the magnetic force is used for efficient usage range. This results in a linear resonant actuator with fast response time and power saving to replace traditional eccentric rotary motor.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A linear resonant actuator, comprising:
A movable element group, further includes a yoke and a pair of magnet set, with same magnetic poles of said pair of magnet set disposed on two corresponding sides of said yoke;
a pair of elastic member, includes a movable portion connecting end and a fixed end, said movable portion connecting end is connected to said pair of magnet set, said fixed end is fixed to a base;
a coil, disposed on periphery of said yoke, and said coil is fixed to said base;
when a continuous alternating current is applied on said coil, said movable element group is enabled to produce a simple harmonic motion.

2. The linear resonant actuator as claimed in claim 1, wherein said yoke is a guided magnet yoke.

3. The linear resonant actuator as claimed in claim 1, wherein said elastic member is material having spring characteristics.

4. The linear resonant actuator as claimed in claim 3, wherein said material having spring characteristics is a sheet spring having elastic material of copper alloy, or stainless steel.

5. The linear resonant actuator as claimed in claim 1, wherein when no current is applied on the coil, said two elastic members return said movable element group back to the origin point.

6. The linear resonant actuator as claimed in claim 1, wherein said elastic member further includes a suspension spring, said suspension spring is connected to said movable portion connecting end and said fixed end.

7. The linear resonant actuator as claimed in claim 1, wherein spring constant of said elastic member is determined by shape and material of said elastic member, and characteristics adjustment of simple harmonic motion is obtained by adjusting shape or material to a suitable spring constant.

8. The linear resonant actuator as claimed in claim 1, wherein said same magnetic pole is one of N-N pole and S-S pole.

9. The linear resonant actuator as claimed in claim 1, further includes at least one extended movable element group and a coil, connecting a magnet of said pair of magnet set.

10. The linear resonant actuator as claimed in claim 9, wherein said at least one extended movable element group consists of a yoke and a magnet, said yoke is connected to said magnet, and periphery of said yoke is surrounded by said coil.

11. The linear resonant actuator as claimed in claim 10, wherein said yoke is connected to said magnet of said extended movable element group.
